(19) United States
(12) Patent Application Publication
(10) Pub. No.: US 2023/0385318 A1
(43) Pub. Date: Nov. 30, 2023

(54) System for Generation and Use of Pinned Searches

(71) Applicant: Microsoft Technology Licensing, LLC, Redmond, WA (US)

(72) Inventors: Kent Chunkin MAI, Issaquah, WA (US); Suneet SASIDHARAN, Seattle, WA (US)

(21) Appl. No.: 17/828,198

(22) Filed: May 31, 2022

(51) Int. Cl. G06F 16/33; G06F 16/332; G06F 16/338

(52) U.S. Cl. CPC G06F 16/3349; G06F 16/3322; G06F 16/338

(57) ABSTRACT

A method may include executing, on a processing unit, a received search query for an electronic messaging data store according to an entity type and a directory scope; in response to the executing: presenting, on a computing device, results of the search query from the electronic messaging data store; and presenting a user interface option configured to initiate storing the search query as a pinned search; receiving, by the processing unit, an indication that the user interface option was activated; based on receiving the indication, generating a pinned search data structure identifying the entity type and the directory scope; subsequent to the generating, receiving a request to initiate a search of the electronic message data store; and in response to receiving the request, presenting a search panel that identifies the pinned search data structure as an activatable search query.

### BACKGROUND

Search interfaces for email applications allow a user to search in a variety of manners. For example, a user may enter in a search query that results in display of emails from a certain person, that include attachments, and that are from the past week. In some examples, a search interface for the email application may include a list of the most recent searches.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is an illustration of components of a client device and an application server, according to various examples.

FIG. 2 is a user interface diagram of an e-mail search interface, according to various examples.

FIG. 3 is a user interface diagram of e-mail search interface for pinning a search, according to various examples.

FIG. 4 is a user interface diagram of an e-mail search interface, according to various examples.

FIG. 5 is a user interface diagram of e-mail search interface for pinning a search, according to various examples.

FIG. 6 is a user interface diagram of an e-mail search interface, according to various examples.

FIG. 7 is a flowchart illustrating operations of a method to a pin a search, according to various examples.

FIG. 8 is a block diagram illustrating an example machine upon which any one or more of the techniques (e.g., methodologies) discussed herein may be performed, according to an example embodiment.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

Throughout this disclosure, electronic actions may be taken by components in response to different variable values (e.g., thresholds, user preferences, etc.). As a matter of convenience, this disclosure does not always detail where the variables are stored or how they are retrieved. In such instances, it may be assumed that the variables are stored on a storage device (e.g., RAM, cache, hard drive) accessible by the component via an API or other program communication method. Similarly, the variables may be assumed to have default values should a specific value not be described. User interfaces may be provided for an end-user or administrator to edit the variable values in some instances.

In various examples described herein, user interfaces are described as being presented to a computing device. Presentation may include transmitting data (e.g., a hypertext markup language file) from a first device (such as a web server) to the computing device for rendering on a display device of the computing device via a rendering engine such as a web browser. Presenting may separately (or in addition to the previous data transmission) include an application (e.g., a stand-alone application) on the computing device generating and rendering the user interface on a display device of the computing device without receiving data from a server.

Furthermore, the user interfaces are often described as having different portions or elements. Although in some examples these portions may be displayed on a screen at the same time, in other examples the portions/elements may be displayed on separate screens such that not all of the portions/elements are displayed simultaneously. Unless indicated as such, the use of “presenting a user interface” does not infer either one of these options.

Additionally, the elements and portions are sometimes described as being configured for a certain purpose. For example, an input element may be described as being configured to receive an input string. In this context, “configured to” may mean presentation of a user interface element that is capable of receiving user input. Thus, the input element may be an empty text box or a drop-down menu, among others. “Configured to” may additionally mean computer executable code processes interactions with the element/portion based on an event handler. Thus, a “search” button element may be configured to pass text received in the input element to a search routine that formats and executes a structured query language (SQL) query with respect to a database.

One of the problems with searching messages (or other data), for example emails, is that often a user uses a number of different searches per day with no easily accessible method to find the searches again. Some applications may permit a user to see recent searches, however these searches do not solve the issue. For example, a recent search list may only include the most recent five searches. Even if the entire history is listed, a user may not remember which query was the one with the results that the user was trying to recreate.

An email application may allow for saved searches in some context, but these saved searches are often listed in separate user interface elements than the search interface itself. Additionally, some email applications provide suggested searches based on a user's frequent searches or context. These suggestions are generally changing, and if a user selects one for search, it may not be available the next time the user decides to search.

Furthermore, a technical challenge is presented when a user attempts to search on a mobile device. Mobile device applications often have a reduced set of functionalities when it comes to composition, as well as searching an existing email database. This is generally because the input area (such as a touch screen) is significantly smaller than a laptop or a computer. Thus, a user may not even be able to (or even functionally be permitted to) create a complex (e.g., using the same options as on a desktop device) search using such a device.

This disclosure describes new systems and methods to overcome the technical challenges related to quickly saving searches, use of saved searches, and the limitations of searching on function-limited devices (e.g., mobile devices). For example, a user may pin a search directly from a suggested searches section of a search panel in an email application, from an advanced search dialog box, or after using a search query bar. The pinned searches may be available directly from the search query interface and synced across multiple user devices. Thus, a complex query may be created on a desktop computer and leveraged and used on a mobile device. This additionally permits a user to not have to re-create their thought process when using a search. A pinned search may include an entity type (such as a sender, date range) as well as a mailbox domain (such as a specific folder, the entire mailbox, or an email archive).

The methods and systems discussed herein are made in the context of searching for emails in an email application, but the methods are not so limited. For example, the methods of pinning searches and using those searches across multiple devices may be used for forum messages, messages in messaging application (e.g., MICROSOFT TEAMS® or SLACK® messaging application), tasks, file searching, etc.

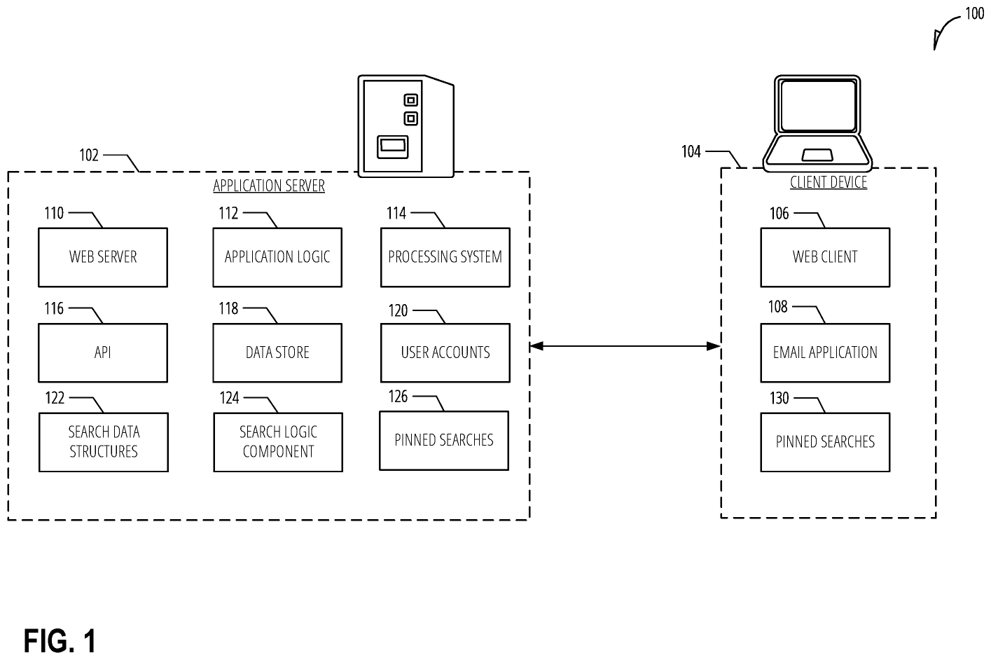

FIG. 1 is an illustration 100 of components of a client device and an application server, according to various examples. FIG. 1 includes application server 102, client device 104, web client 106, email application 108, web server 110, application logic 112, processing system 114, application programming interface (API 116), data store 118, user accounts 120, search data structures 122, search logic component 124, pinned searches 126, and pinned searches 130.

Application server 102 (and client device 104) is illustrated as set of separate elements (e.g., component, logic, etc.). However, the functionality of multiple, individual elements may be performed by a single element. An element may represent computer program code that is executable by processing system 114. The program code may be stored on a storage device (e.g., data store 118) and loaded into a memory of the processing system 114 for execution. Portions of the program code may be executed in a parallel across multiple processing units (e.g., a core of a general purpose computer processor, a graphical processing unit, an application specific integrated circuit, etc.) of processing system 114. Execution of the code may be performed on a single device or distributed across multiple devices. In some examples, the program code may be executed on a cloud platform (e.g., MICROSOFT AZURE® and AMAZON EC2®) using shared computing infrastructure.

Client device 104 may be a computing device which may be, but is not limited to, a smartphone, tablet, laptop, multi-processor system, microprocessor-based or programmable consumer electronics, game console, set-top box, or other device that a user utilizes to communicate over a network. In various examples, a computing device includes a display module (not shown) to display information (e.g., in the form of specially configured user interfaces). In some embodiments, computing devices may comprise one or more of a touch screen, camera, keyboard, microphone, or Global Positioning System (GPS) device.

Client device 104 and application server 102 may communicate via a network (not shown). The network may include local-area networks (LAN), wide-area networks (WAN), wireless networks (e.g., 802.11 or cellular network), the Public Switched Telephone Network (PSTN) Network, ad hoc networks, cellular, personal area networks or peer-to-peer (e.g., Bluetooth®, Wi-Fi Direct), or other combinations or permutations of network protocols and network types. The network may include a single Local Area Network (LAN) or Wide-Area Network (WAN), or combinations of LAN's or WAN's, such as the Internet.

Client device 104 and application server 102 may transmit data over the network. For example, a user may initiate a search via client device 104 that is transmitted to application server 102 for completion. In another example, certain user account data may be synced between application server 102 and client device 104 such as pinned searches. Thus, if a user pins a search on client device 104, an API call may be transmitted to application server 102 to update pinned searches 126 (e.g., using a search data structure as a payload as discussed further herein). Furthermore, client devices may periodically poll (e.g., every minute) application server 102 with an update pinned searches API call requesting any changes (e.g., additions or deletions) made to the pinned searches for a user. In response, a diff (e.g., changes made to pinned searches 126 since the last polling call from the client device) or all of pinned searches 126 may be transmitted back to the polling device. The polling device may update their local search repository (e.g., pinned search 130) based on the diff or simply replace their existing repository with the new received set. In other examples, if another client device (not shown) pins a search, application server 102 may proactively push a message to client device 104 to update pinned searches 130. API 116 may also respond to calls for a list of saved searches (e.g., pinned searches 130). For example, the API call may take a user identifier as input and application server 102 may return a pinned search set (e.g., in a standardized format such as JavaScript Object Notation) that matches the user identifier.

As indicated, the communication may occur using an application programming interface (API) such as API 116. An API provides a method for computing processes to exchange data. A web-based API (e.g., API 116) may permit communications between two or more computing devices such as a client and a server. The API may define a set of HTTP calls according to Representational State Transfer (RESTful) practices. For examples, A RESTful API may define various GET, PUT, POST, DELETE methods to create, replace, update, and delete data stored in a database (e.g., data store 118).

APIs may also be defined in frameworks provided by an operating system (OS) to access data in an application that an application may not regularly be permitted to access. In another example, an application provider may use an API call to request a user be authenticated using a biometric sensor on the mobile device. By segregating any underlying biometric data—e.g., by using a secure element—the risk of unauthorized transmission of the biometric data may be lowered while still providing the enhanced confidence of using biometric authentication.

Application server 102 may include web server 110 to enable data exchanges with client device 104 via web client 106 and provide services (e.g., as an email server). Although generally discussed in the context of delivering webpages/data via the Hypertext Transfer Protocol (HTTP), other network protocols may be utilized by web server 110 (e.g., File Transfer Protocol, Telnet, Secure Shell, etc.). A user may enter in a uniform resource identifier (URI) into web client 106 (e.g., the INTERNET EXPLORER® web browser by Microsoft Corporation or SAFARI® web browser by Apple Inc.) that corresponds to the logical location (e.g., an Internet Protocol address) of web server 110. In response, web server 110 may transmit a web page that is rendered on a display device of a client device (e.g., a mobile phone, desktop computer, etc.).

Additionally, web server 110 may enable a user to interact with one or more web applications (e.g., an email application) provided in a transmitted web page. A web application may provide user interface (UI) components that are rendered on a display device of client device 104. The user may interact (e.g., select, move, enter text into) with the UI components, and, based on the interaction, the web application may update one or more portions of the web page. A web application may be executed in whole, or in part, locally on client device 104. The web application may populate the UI components with data from external sources or internal sources (e.g., data store 118) in various examples.

The web application may be executed according to application logic 112. Application logic 112 may use the various elements of application server 102 to implement the web application. For example, application logic 112 may issue API calls to retrieve or store data from data store 118 and transmit it for display on client device 104. Similarly, data entered by a user into a UI component may be transmitted using API 116 back to the web server 110. Application logic 112 may use other elements (e.g., search data structures 122, search logic component 124, pinned searches 126, etc.) of application server 102 to perform functionality associated with the web application as described further herein.

The web application may be an application suite of applications such an email application, a calendar application, a task application, a word processing application, etc., in various examples. Data for the application suite may be stored in data store 118 in various examples. Non-web-based versions of the application suite may be executed on client devices as well (e.g., email application 108). Documents/email created on the non-web-based applications (and vice versa) may be synced with application server 102 in various examples.

Data store 118 may store data that is used by application server 102. Data store 118 is depicted as singular element, but may in actuality be multiple data stores. The specific storage layout and model used in by data store 118 may take a number of forms—indeed, a data store 118 may utilize multiple models. Data store 118 may be, but is not limited to, a relational database (e.g., SQL), non-relational database (NoSQL) a flat file database, object model, document details model, graph database, shared ledger (e.g., blockchain), or a file system hierarchy. Data store 118 may store data on one or more storage devices (e.g., a hard disk, random access memory (RAM), etc.). The storage devices may be in standalone arrays, part of one or more servers, and may be located in one or more geographic areas. Similarly, although not depicted, client device 104 may include a data store as well.

In various examples, data store 118 stores pinned searches 126, which are formatted in accordance with search data structures 122. A search data structure may include one or more entity types, values for the one or more entity types and a search scope. The entity types, their values, and the search scope may be considered the search criteria, in various examples.

An entity type may be a property of the searched for data object (e.g., an email, a calendar event). In the context of an email message, an entity type may be a sender, whether or not the email includes an attachment, and importance value, a date sent, a subject, etc. Different entity types may have different allowable values. For example, an importance entity type may include possible values of low, none, or high. A listing of the entity types and their allowed values may be stored in data store 118, in various examples.

A search scope made limit the search space for the data objects that are to be retrieved. For example, in the context of emails, a search scope may define which folders in which mailbox to search. Thus, a user may indicate a directory scope that limits the search to just a user's sent items, in various examples.

Search logic component 124 may be used to find data objects in accordance with a search data structure. For example, an index of e-mails may be searched for e-mails that meet the search criteria of the search data structure.

User accounts 120 may include user profiles on users of application server 102. A user profile may include credential information such as a username and hash of a password. A user may enter in their username and plaintext password to a login page of application server 102 to view their user profile information or interfaces presented by application server 102 in various examples.

A user account may also identify computing devices associated with the user. For example, a user may register one or more phones, desktop computers, tablets, or laptops with application server 102. Registering may include authorizing application server 102 to retrieve data such as location data, browser history, etc., from these devices. Authorizing may further permit application server 102 to sync data with the devices (e.g., such as pinned searches). A user may revoke access to any such data at any time by updating their user profile. The data may be gathered via an application installed on one of the registered devices such as by downloading an application from an app store associated with the platform of their mobile phone.

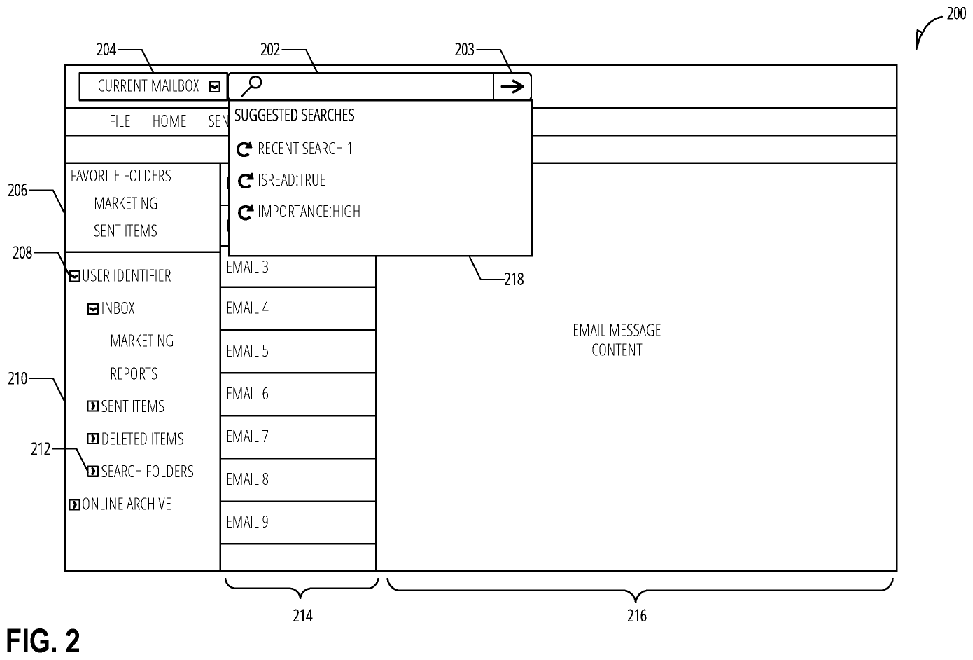

FIG. 2 through FIG. 6 present a progression of potential user actions through a series of user interfaces for pinning searches. Accordingly, there are some common element labels that appear across the diagrams.

FIG. 2 is a user interface diagram 200 of an e-mail search interface, according to various examples. The user interface diagram 200 may be presented to a user on a client device via an application (e.g., client device 104 and email application 108 or web client 106). User interface diagram 200 is presented as including search query text input element 202, search activation element 203, search scope selector 204, favorite folders 206, a user identifier 208, directory hierarchy 210, search folders 212, e-mail column 214, message content pane 216, and search panel 218. Although user interface diagram 200 presents certain spatial relationships and uses specific labels, other arrangements and labels may be used without departing from the scope of this disclosure.

User identifier 208 may correspond to the email address that is tied to the user account on application server 102. Accordingly, directory hierarchy 210 may correspond to folders the user has created in the manner they were nested by the user. The hierarchy may be maintained in user accounts 120 on application server 102 in various examples.

Search folders 212 may be specific to the computing device/application the user is currently using and may not be synced back to the user account in various examples. A search folder may be search that has been saved by the user but exists as part of the directory structure and not the search interface. Thus, if a user wishes to use a search folder, they do not select search query text input element 202 or search scope selector 204. Consequently, a user may have a set of pinned searches and a set of search folders that may or may not overlap (e.g., if a user chooses to create a saved folder and pin the search with a similar query).

In various examples, a user may activate search query text input element 202 by clicking anywhere within the element. Upon activation, search panel 218 may be presented as a drop-down panel from search query text input element 202. Search panel 218 may include one or more portions. A first (for labeling purposes, not as an order) portion may include suggested searches such as a listing of the three most recent searches a user has made or frequent contacts. A second portion may include pinned searches. As seen, search panel 218 does not have any pinned searches at the present time.

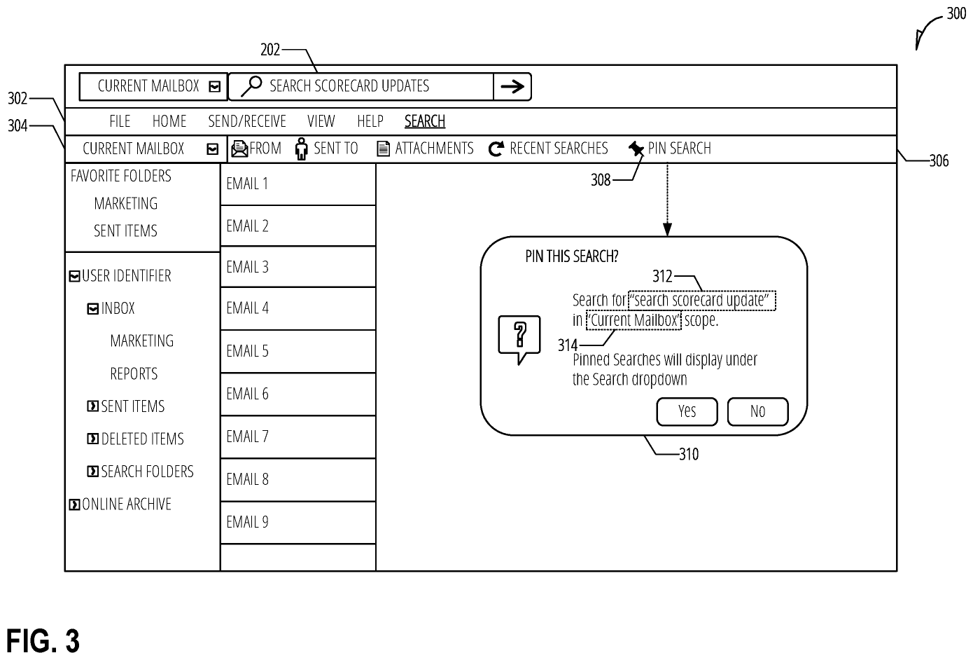

FIG. 3 is a user interface diagram 300 of e-mail search interface for pinning a search, according to various examples. User interface diagram 300 may be shown after a user has begun to type in a search query to search query text input element 202 and selected (e.g., clicked) search activation element 203. As seen, within search query text input element 202 a user has entered “search scorecard updates.” In response, the email application has conducted a search of electronic messaging data store (e.g., data store 118 or a local version of the same) and the resulting messages may be presented in e-mail column 214.

Once a user has activated search query text input element 202, menu bar 302 may be updated to include a new label “Search” and search toolbar 306 may be presented. Search toolbar 306 may include search scope 304 and a list of entity types that may be selected to further refine the search. Additionally, pin search element 308 may be presented.

When a user selects pin search element 308, a confirmation dialog box may be presented such as confirmation dialog box 310 that includes a message to confirm that the user wishes to pin the search. The message with confirmation dialog box 310 may be based on the search that was entered into search query text input element 202. For example, the message may include a search query listing 312 that identifies any message entity types to search and a directory scope 314.

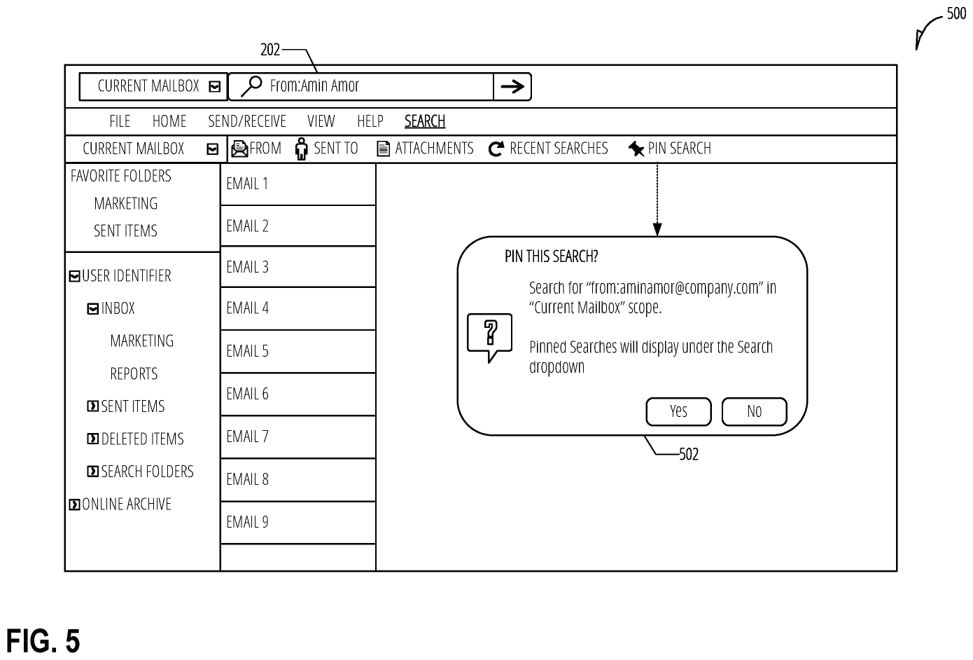

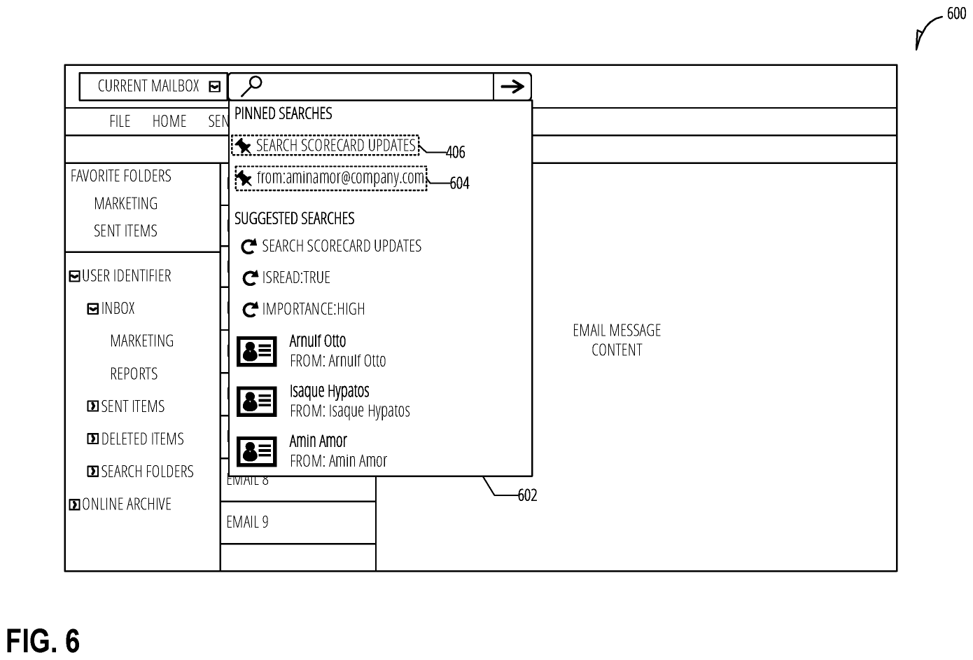

In the case of confirmation dialog box 310, the listing 312 is a free form text entity type such that all entity fields (e.g., from, sent to) may be searched for “search scorecard update”. A more filtered search is discussed in the context of FIG. 5 and FIG. 6. The directory scope 314 for confirmation dialog box 310 indicates that the current mailbox will be searched. If a user had selected a narrower scope (e.g., by selecting a specific folder using search scope 304) the message may indicate the name of the folder.

When a user affirms that they wish to pin the search, a search data structure may be created by the email application using the search criteria identified by the user and presented in confirmation dialog box 310. The search data structure may be stored as part of pinned searches 130 or pinned searches 126 in various examples as associated with a user account.

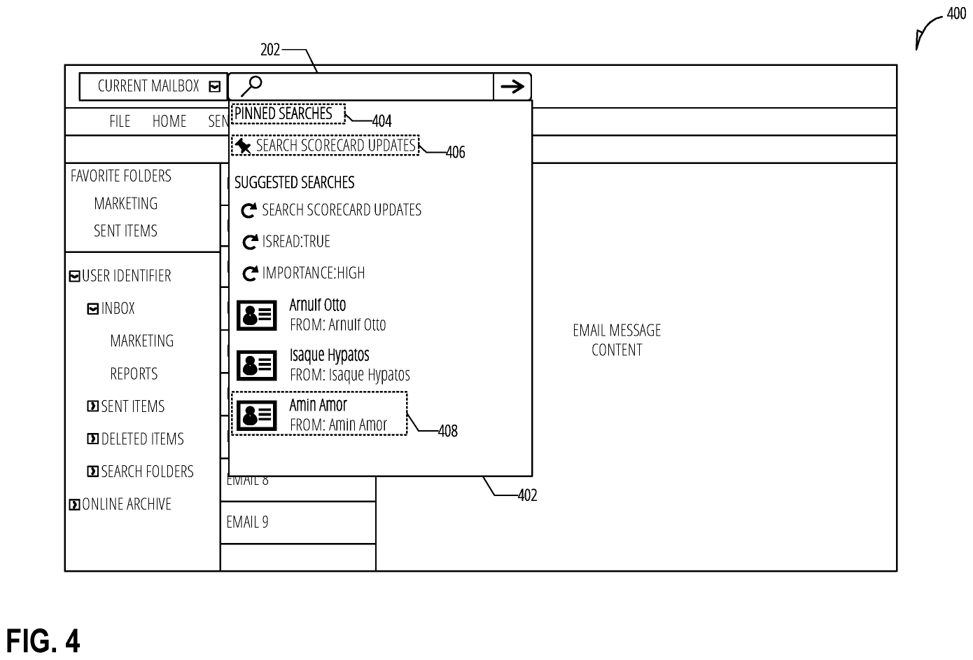

FIG. 4 is a user interface diagram 400 of an e-mail search interface, according to various examples. User interface diagram 400 may be presented after a user has confirmed they wished to pin the previous search and have begun to conduct another search. In this instance, search panel 402 may be presented. Search panel 402 includes two portions, a suggested searches portion and a pinned search portion 404. The list of pinned searches presented in pinned search portion 404 may be based on an API call to retrieve the list of pinned searches associated with the user's account. Here, it can be seen that there is one pinned search, pinned search 406, which corresponds to the search described in the prior figures.

A user may select a pinned search to have it automatically executed according to the search criteria (e.g., entity type, entity type value, and scope) identified in the corresponding search data structure. When executed, the results may be shown as if the user had typed in the same search and activated the search (e.g., using search activation element 203 with reference to FIG. 2). A user may select the pin icon in pinned search 406 to unpin the search, in various examples. Upon confirming the user wishes to unpin the search, the search data structure may be deleted from pinned searches 126 and pinned searches 130.

In addition to the recent searches, search panel 402 identifies three searches with respect to three contacts. Although these suggestions are contact based, other suggestions may be made such as listing frequent searches, etc. A user may select one of the suggested searches (e.g., suggested search 408) to have the search initiated. In various example, a pin icon of a different format (e.g., different color) than the pin in pinned search 406 may be presented next to each suggested search to allow the user to pin the suggested search right away.

FIG. 5 is a user interface diagram 500 of e-mail search interface for pinning a search, according to various examples. User interface diagram 500 may be displayed after a user has selected pinned search 406 in various examples. User interface diagram 500 is similar to user interface diagram 300 in that it assumes a user has selected the pin search option from the search tool bar. Confirmation dialog box 502 may be presented that confirms that the user wishes to pin the search for “from:Amin Amor.” In this instance the “from” portion identifies the entity type that is being searched and “Amin Amor” is the value. As a further user interface hint to the user, the search itself has been automatically placed into search query text input element 202.

FIG. 6 is a user interface diagram 600 of an e-mail search interface, according to various examples. User interface diagram 600 may be presented after the user has confirmed to pin the search discussed in FIG. 5. Search panel 602 includes both the pinned search from FIG. 4 (e.g., pinned search 406) and pinned search 604 based on the search of FIG. 5.

Another entry point to a pinned search may be an advanced search interface. For example, in contrast to the items on search toolbar 306, an advanced search interface may allow for Boolean logic and more complex search queries with multiple conditions. After an advanced search is initiated, the search may be pinned in a similar manner as described for the search query bar and suggested search entry points above.

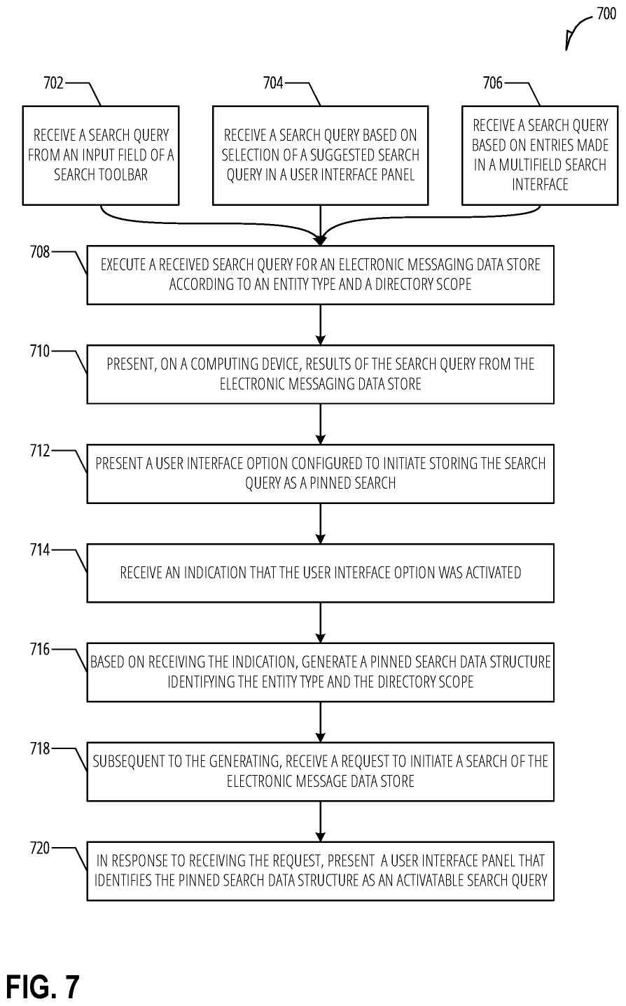

FIG. 7 is a flowchart illustrating operations of a method to a pin a search, according to various examples. The method is represented as a set of blocks that describe operations 702 to 720 of flowchart 700. The method may be embodied in a set of instructions stored in at least one computer-readable storage device of a computing device(s). A computer-readable storage device excludes transitory signals. In contrast, a signal-bearing medium may include such transitory signals. A machine-readable medium may be a computer-readable storage device or a signal-bearing medium. The computing device(s) may have one or more processors that execute the set of instructions to configure the one or more processors to perform the operations illustrated in FIG. 7. The one or more processors may instruct other component of the computing device(s) to carry out the set of instructions. For example, the computing device may instruct a network device to transmit data to another computing device or the computing device may provide data over a display interface to present a user interface. In some examples, performance of the method may be split across multiple computing devices using a shared computing infrastructure.

In various examples, at operation 702, the method may include receiving a search query from an input field (e.g., search query text input element 202) of a search tool bar. In various examples, at operation 704, the method may include receiving a search query based on selection of a suggested search query in a user interface panel (e.g., search panel 402). For example, a user may be presented with a search panel that includes a set of suggested searches where the search query may be based on selection of a suggested search of the set of suggested searches. In various examples, at operation 706, the method may include receiving a search query based on entries made in a multi-field search interface (e.g., an advanced search interface supporting Boolean logic).

In various examples, at operation 708, the method may include executing, on a processing unit, a received search query (e.g., from one of operations 702, 704, or 706) for an electronic messaging data store (e.g., an email database as stored in a data store) according to an entity type and a directory scope. The entity type may be a searchable field of an email message stored in the electronic messaging data store (e.g., an importance field, to field, etc.). The directory scope may identify the scope of emails to search within the data store. For example, certain mailboxes or folders within a mailbox may be searched.

Operations 710-716 may be performed in response to the executing of operation 708. For example, at operation 710, the method may include presenting, on a computing device (e.g., client device 104), results of the search query from the electronic messaging data store. The results may be determined by a search conducted locally on the computing device or conducted on a server device (e.g., application server 102 using search logic component 124). The results may include a set of emails that match the search criteria of the search query and be presented in a message column (e.g., e-mail column 214).

In various examples, at operation 712, the method may include presenting a user interface option (e.g., pin search element 308) configured to initiate storing the search query as a pinned search. The user interface option may be presented in a search toolbar. In various examples, at operation 714, the method may include receiving, by the processing unit, an indication that the user interface option was activated. Activation may include a user clicking with an input device on the option.

In various examples, at operation 716, the method may include based on receiving the indication, generating a pinned search data structure (e.g., search data structures 122) identifying the entity type and the directory scope. In further response to receiving the indication, a confirmation message may be generated that includes an identification of the entity type (e.g., indicates “from” or “importance”) and the directory scope, and the confirmation message may be presented.

In various examples, at operation 718, the method may include subsequent to the generating, receiving a request to initiate a search of the electronic message data store. For example, the request may be based on a user clicking within a search text input field (e.g., search query text input element 202).

In various examples, at operation 720, the method may include in response to receiving the request, presenting a user interface panel that identifies the pinned search data structure as an activatable search query. For example, an icon may be presented next to a label of the search such as depicted in pinned search 406. Activatable may mean that if a user clicks on the pinned search, a search is initiated. In various examples, the method may include updating a pinned search data store of the computing device with the pinned search data structure.

The pinned search data store of the computing device may be updated in a variety of ways. For example, if the user decides to delete a search, the pinned search data structure may be removed from the pinned search data store. A delete pinned search request API call may be made to the server device with an identification of the deleted search data structure so that a server-based pinned search data store may be updated to match.

Additionally, the computing device may periodically transmit an API message to the server device for updates associated with the pinned search data store (e.g., searches added or deleted on other device). In response to the polling, an instruction may be received to delete a second pinned search data structure from the pinned search data store. The instruction may be in the form of a JSON message with an identification of the pinned search and a command to delete the pinned search.

If the pinned search data structure was generated on a non-server device (e.g., client device 104), an API message may be transmitted to a server device (e.g., application server 102) with the pinned search data structure. The API message may be an add pinned search API that updates the server's pinned search datastore, for example, by adding the pinned search data structure to pinned searches 126. Similarly, a delete pinned search API call may be used to delete a pinned search data structure from pinned searches 126.

In various examples, the method may further include receiving, from a second computing device, an indication of a user to search the electronic messaging data store. For example, the first computing device of operation 710 may be a desktop computer and the second computing device may be a mobile phone. In response the method may include accessing a pinned search data store associated with the user (e.g., pinned searches 126) by transmitting a request to application server 102.

The method may include presenting, in a search panel, a listing of pinned searches based on search data structures stored in the pinned search data store and receiving a selection of a pinned search from the listing. A search may be initiated of electronic messaging data in accordance with the selection.

Embodiments described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

Examples, as described herein, may include, or may operate on, logic or a number of components, modules, or mechanisms. Modules may be hardware, software, or firmware communicatively coupled to one or more processors in order to carry out the operations described herein. Modules may hardware modules, and as such modules may be considered tangible entities capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine-readable medium.

In an example, the software, when executed by the underlying hardware of the module, causes the hardware to perform the specified operations. Accordingly, the term hardware module is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software; the general-purpose hardware processor may be configured as respective different modules at different times. Software may accordingly configure a hardware processor, for example, to constitute a particular module at one instance of time and to constitute a different module at a different instance of time. Modules may also be software or firmware modules, which operate to perform the methodologies described herein.

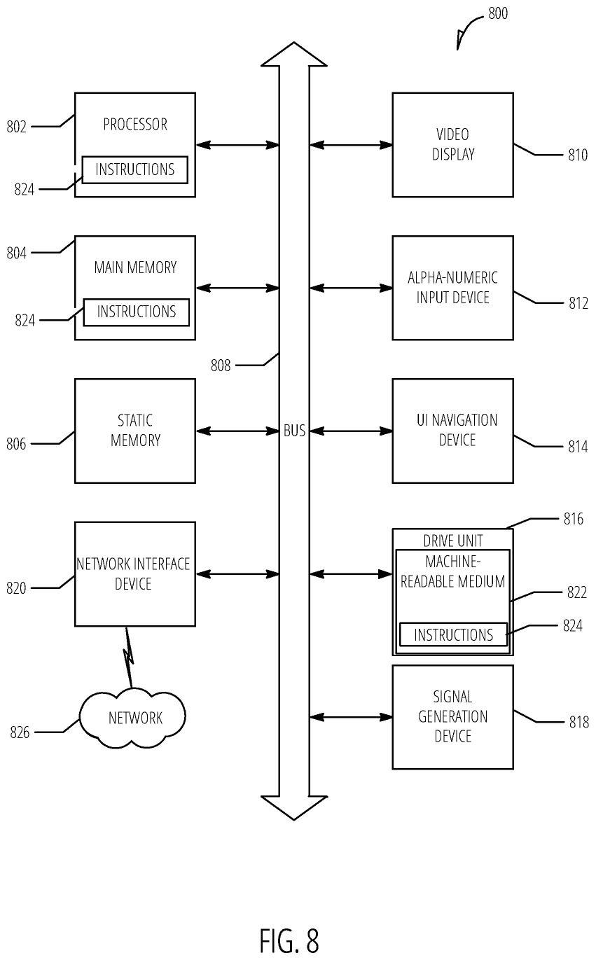

FIG. 8 is a block diagram illustrating a machine in the example form of a computer system 800, within which a set or sequence of instructions may be executed to cause the machine to perform any one of the methodologies discussed herein, according to an example embodiment. In alternative embodiments, the machine operates as a standalone device or may be connected (e.g., networked) to other machines. In a networked deployment, the machine may operate in the capacity of either a server or a client machine in server-client network environments, or it may act as a peer machine in peer-to-peer (or distributed) network environments. The machine may be an onboard vehicle system, wearable device, personal computer (PC), a tablet PC, a hybrid tablet, a personal digital assistant (PDA), a mobile telephone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example computer system 800 includes at least one processor 802 (e.g., a central processing unit (CPU), a graphics processing unit (GPU) or both, processor cores, compute nodes, etc.), a main memory 804 and a static memory 806, which communicate with each other via a link 808 (e.g., bus). The computer system 800 may further include a video display unit 810, an input device 812 (e.g., a keyboard), and a user interface (UI) navigation device 814 (e.g., a mouse). In one embodiment, the video display unit 810, input device 812 and UI navigation device 814 are incorporated into a touch screen display. The computer system 800 may additionally include a storage device 816 (e.g., a drive unit), a signal generation device 818 (e.g., a speaker), a network interface device 820, and one or more sensors (not shown), such as a global positioning system (GPS) sensor, compass, accelerometer, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the computer system 800, with the main memory 804, static memory 806, and the at least one processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, 4G LTE/LTE-A or WiMAX networks, and 5G). The term “transmission medium” shall be taken to include any intangible medium that is capable of storing, encoding, or carrying instructions for execution by the machine, and includes digital or analog communications signals or other intangible medium to facilitate communication of such software.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

1. A method comprising:
executing, on a processing unit of a computing device, a search query for an electronic messaging data store, the search query i) received via a search panel of a user interface for an electronic messaging application, and ii) specifying an entity type and a directory scope;
in response to the executing:
presenting, via the user interface of the electronic messaging application at the computing device, results of the search query from the electronic messaging data store; and
presenting, via the user interface, an option, which, when selected, is configured to initiate storing the search query as a pinned search;
receiving, by the processing unit, an indication that the user interface option was activated;
based on receiving the indication, generating and storing a pinned search data structure identifying the entity type and the directory scope;
subsequent to the generating, receiving a request to initiate a search of the electronic message data store; and
in response to receiving the request, presenting the search panel identifying the pinned search data structure as an activatable search query.

2. The method of claim 1, wherein the received search query is received from a search query text input element.

3. The method of claim 1, further comprising:
presenting, in the search panel, a set of suggested searches; and
wherein the search query is based on selection of a suggested search of the set of suggested searches.

4. The method of claim 1, wherein presenting the user interface option configured to initiate storing the search query includes presenting the user interface option in a search toolbar.

5. The method of claim 1, further comprising based on receiving the indication:
generating a confirmation message, the confirmation message including an identification of the entity type and the directory scope; and
presenting the confirmation message.

6. The method of claim 5, wherein the entity type is an importance entity.

7. The method of claim 5, wherein the directory scope designates a folder of the electronic messaging data store.

8. The method of claim 1, further comprising:
transmitting an add pinned search application programming interface (API) message to a server device with the pinned search data structure.

9. The method of claim 8, further comprising:
updating a pinned search data store of the server device with the pinned search data structure.

10. The method of claim 9, further comprising:
polling, using an application programming interface (API) message, a server device for updates associated with the pinned search data store;
in response to the polling, receiving an instruction to delete a second pinned search data structure from the pinned search data store.

11. The method of claim 9, further comprising:
receiving a request from the user to delete the pinned search data structure; and
in response to the request from the user, transmitting a delete pinned search API call to the server device.

12. The method of claim 1, further comprising:
receiving, from a second computing device, an indication of a user to search the electronic messaging data store, and in response:
accessing a pinned search data store associated with the user;
presenting, in a search panel, a listing of pinned searches based on search data structures stored in the pinned search data store;
receiving a selection of a pinned search from the listing; and
initiating a search of the electronic messaging data in accordance with the selection.

13. A system comprising:
at least one processor;
a storage device comprising instructions, which when executed by the at least one processor, configure the at least one processor to perform operations comprising:
executing, on a processing unit of a computing device, a search query for an electronic messaging data store, the search query i) received via a search panel of a user interface for an electronic messaging application, and ii) specifying an entity type and a directory scope;
in response to the executing:
presenting, via the user interface of the electronic messaging application at the computing device, results of the search query from the electronic messaging data store; and
presenting, via the user interface, an option, which, when selected, is configured to initiate storing the search query as a pinned search;
receiving, by the processing unit, an indication that the user interface option was activated;
based on receiving the indication, generating and storing a pinned search data structure identifying the entity type and the directory scope;
subsequent to the generating, receiving a request to initiate a search of the electronic message data store; and
in response to receiving the request, presenting the search panel identifying the pinned search data structure as an activatable search query.

14. The system of claim 13, wherein the received search query is received from a search query text input element.

15. The system of claim 13, wherein the instructions, which when executed by the at least one processor, further configure the at least one processor to perform operations comprising:
based on receiving the indication:
generating a confirmation message, the confirmation message including an identification of the entity type and the directory scope; and
presenting the confirmation message.

16. The system of claim 13, wherein presenting the user interface option configured to initiate storing the search query includes presenting the user interface option in a search toolbar.

17. A computer-readable storage device comprising instructions, which when executed by at least one processor, configure the at least one processor to perform operations comprising:
executing, on a processing unit of a computing device, a search query for an electronic messaging data store, the search query i) received via a search panel of a user interface for an electronic messaging application, and ii) specifying an entity type and a directory scope;
in response to the executing:
presenting, via the user interface of the electronic messaging application at the computing device, results of the search query from the electronic messaging data store; and
presenting, via the user interface, an option, which, when selected, is configured to initiate storing the search query as a pinned search;
receiving, by the processing unit, an indication that the user interface option was activated;
based on receiving the indication, generating and storing a pinned search data structure identifying the entity type and the directory scope;
subsequent to the generating, receiving a request to initiate a search of the electronic message data store; and
in response to receiving the request, presenting the search panel identifying the pinned search data structure as an activatable search query.

18. The computer-readable storage device of claim 17, wherein the received search query is received from a search query text input element.

19. The computer-readable storage device of claim 17, wherein the instructions, which when executed by the at least one processor, further configure the at least one processor to perform operations comprising:
based on receiving the indication:
generating a confirmation message, the confirmation message including an identification of the entity type and the directory scope; and
presenting the confirmation message.

20. The computer-readable storage device of claim 17, wherein presenting the user interface option configured to initiate storing the search query includes presenting the user interface option in a search toolbar.
